(19) United States
(12) Patent Application Publication
(10) Pub. No.: US 2021/0283617 A1
(43) Pub. Date: Sep. 16, 2021

(54) STORAGE DEVICE AND ASSEMBLY FOR VIALS

(71) Applicant: Jim MANOLIOS, Victoria (AU)

(72) Inventor: Jim MANOLIOS, Victoria (AU)

(21) Appl. No.: 16/321,717

(22) PCT Filed: Jul. 28, 2017
(86) PCT No.: PCT/AU2017/000156

§ 371 Date: Jan. 29, 2019

(30) Foreign Application Priority Data
Jul. 29, 2016 (AU) 2016902987

(51) Int. Cl. B01L 9/06

(52) U.S. Cl. CPC B01L 9/06; B01L 2300/0858; B01L 2200/028; B01L 2200/025

(57) ABSTRACT

A storage device for holding at least one article the device comprising a generally cubic body including side and end walls defining an internal space which receives and retains therein said at least one said articles, at least one said walls including an inwardly extending formation which allows the at least one article to be suspended in the internal space; at least one said walls including a recess which allows nesting engagement of one said device with a like storage device such that at least one device is stackable on another like device; while accommodating said articles in said internal space.

### BACKGROUND

The present invention relates to diagnostic apparatuses and equipment and more specifically relates to a method and apparatus for storage of reagent and specimen containers and equipment used in laboratory testing. More specifically the present invention relates to an apparatus for storage of Gel Cards which are used in blood group Serology testing and which allow efficient storage, packing for transportation with a reduced footprint. The present invention also relates to a method of storing and handling gel cards which reduces the space required for storage and transportation of such gel cards. More specifically the present invention relates to a method and apparatus to enable an increase in the number of Gel Cards that can be stored in a small area for packaging, transport, manual use or integration with an automated analyzer. Although the present invention has potentially wide application, it will primarily be described with reference to its use in storage of laboratory vials and containers for reagents, specimens and the like.

### PRIOR ART

A serological blood test is performed to detect and measure the levels of antibodies as a result of exposure to a particular bacteria or virus. When people are exposed to bacteria or viruses (antigens), their body's immune system produces specific antibodies against the organism. Serology is the scientific study of serum and other bodily fluids. In practice, the term usually refers to the diagnostic identification of antibodies in the serum.

Such antibodies are typically formed in response to an infection (against a given microorganism), against other foreign proteins (in response, for example, to a mismatched blood transfusion), or to one's own proteins (in instances of autoimmune disease). Serological tests may be performed for diagnostic purposes when an infection is suspected, in rheumatic illnesses, and in many other situations, such as checking an individual's blood type.

Serologic blood tests look for antibodies in the blood. They can involve a number of laboratory techniques. Different types of serologic tests can diagnose various disease conditions. Serologic tests all have in common that they all focus on proteins made by the immune system. Gel tests are known for the determination of immunoglobulin classes and subclasses and complement fractions coating RBCs. Gel technology is based on the principle of controlled centrifugation of red cells through a dextran-acrylamide-gel.

Gel Cards are relatively large mass substantially planar containers of plastics with a plurality of wells which receive samples and reagents before they are centrifuged. The gel card is essentially a group of spaced apart vials which are integrated into a card shaped spine. In the Gel test, the laboratory requires Gel Cards (with preloaded Gel, buffer and anti-human globulin (AHG) reagent), reagent red cells (human red cells of known antigenic profile manufactured to be used in the test system). Gel Cards are now the world's leading system for performing blood group serology testing. Throughout their time, they have been transported and stored in racks of 10 or 12 in a single row, one behind the other. These racks have been made of plastics or cardboard and have generally been supplied in an outer box as a single unit or in boxes where the racks were next to each other in a single row—for larger boxes, multiple rows are stacked on top of each other. The various analyzers used in blood banking require the user to either place the cards on the instrument one at a time or accept these single row racks and the instrument identifies, sorts and picks up the cards individually for use in the instrument.

There are a number of disadvantages which are associated with the current systems and methodology for storage and transportation of the gel cards. Firstly, the racks take up a significant space and in fact, they more than double the volume of the cards they are holding. As gel cards must be air freighted, the space they take up increases transportation and storage costs. On many instruments the user must take the cards out of the rack one at a time and place them on the instrument for use, this is very time consuming and is a tedious job that can lead to errors if a card is incorrectly located by the user.

This known methodology causes significant packaging waste and where the existing racks are placed directly on an analyzer, they consume a significant amount of very expensive space in the instrument. As a result, this makes the instruments bulky and difficult to maintain (since the instruments need to be able to manipulate this large volume of racks for varying types of cards).

In view of the aforesaid disadvantages of the known art, there is a need to improve the methodology and equipment associated with the packaging, storage and transportation of gel cards and to provide an alternative to and overcome the disadvantages of the known methods which add to costs. There is also a need to increase the efficiency of Serological testing and particularly the testing using gel cards in order to overcome or at least ameliorate the shortcomings of the prior art methodology.

### INVENTION

The present invention provides an improved apparatus for storage of Gel Cards which are used in blood group Serology testing and which allows efficient storage, packing for transportation with a reduced footprint. The present invention also provides a method of storing and handling gel cards which reduces the space required for storage and transportation of such gel cards. More specifically the present invention provides a method and apparatus to enable an increase in the number of Gel Cards that can be stored in a small area for packaging, transport, manual use and/or integration with an automated analyzer. The invention further provides a stackable modular receptacle which accommodates a plurality of gel cards and which can be stacked one on top of the other to increase space efficiency and reducing handling time.

In one broad form the present invention comprises:

a storage device for holding at least one article the device comprising a generally cubic body including a wall and a ground engaging support which at least partially define an internal space which receives and retains therein said at least one said articles, an article entry formation extending from the wall and which includes at least one opening which allows insertion of a part of said at least one article at least partially into said body, at least part of the support having an external formation which allows nesting engagement with a like device such that at least one device is stackable on another device; at least part of said wall having a distal edge capable of providing support for the device and an upper edge; the external formation in the wall receiving and retaining a corresponding distal edge of a second like device.

Preferably there are a plurality of openings in an upper surface which allow insertion of a plurality of gel cards at last partially into said body. According to a preferred embodiment, the entry wall is an upper wall which includes a plurality of elongated slot like openings to receive said articles. The elongated slots allow elongated generally planar articles to enter the device. Accordingly, the openings are shaped and sized to accommodate the shape and size of the articles inserted therein.

In another broad form the present invention comprises:

a modular storage receptacle for holding a plurality of like articles the receptacle comprising a generally cubic body including side and end walls and a ground engaging support which at least partially define an internal space which receives and retains said articles suspended therein, at least one article entry opening extending inwardly from a wall which allows insertion of said articles at least partially into said body; at least part of the support having a wall formation which allows nesting engagement with a like device such that one device is stackable with at least one other receptacle; at least one said side wall having a distal edge capable of providing support for the receptacle and an upper edge; a formation at or near the upper edge which receives and retains a corresponding distal edge of a like receptacle.

Preferably each article sits above the upper wall surface sufficient to allow gripping of the articles for removal from the device,

In another broad form the present invention comprises:

a modular storage receptacle for holding a plurality of gel cards; the device comprising a generally cubic body including an article entry wall, side and end walls each terminating in a distal edge which supports the device when disposed on a support surface; the entry wall, side and end walls defining an internal space which receives and at least partially retains said plurality of gel cards; each said side wall including an upper proximal edge at least part of which is integral with an edge of said upper entry wall; a formation in each said wall which matches a distal edge formation in a wall of a corresponding receptacle, wherein in a stacked state a distal edge of a wall of one device locates in a corresponding wall formation in a proximal edge part of a second receptacle thereby enabling inter fitting of one receptacle to another like receptacle.

In another broad form the present invention comprises; a modular receptacle comprising a generally cubic body defined by walls defining an internal space, formations extending from said side walls including a plurality of openings which receive and retain therein a plurality of articles suspended in the internal space; at least a part of one wall including a formation defined by an upper edge and a lower edge forming a recess, the formation in said wall allowing the modular receptacle to receive and retain a like receptacle in nesting/stacked relationship.

Preferably each said side wall includes a recess located proximally and which receives a distal edge formation of a like receptacle. An internal space receives and at least partially retains therein said gel cards. The device includes an article entry opening which includes a plurality of openings which allow insertion of the gel cards at least partially into the body. At least part of the walls include a formation which allows nesting engagement with a like receptacle such that at least one receptacle is stackable on another device. At least one side wall has a distal edge capable of providing support for the device and an upper edge; a formation at or near the upper edge receives and retains a corresponding distal edge of a like receptacle.

According to a preferred embodiment, the formations which retain the articles include a plurality of elongated slot like openings to receive said articles. The elongated slots allow planar gel cards articles to enter the slots so that vials associated with the gel cards seat in formed recesses. Accordingly the openings are shaped and sized to accommodate the shape and size of the gel cards inserted therein. Throughout the specification a reference to the term gel card can be taken to mean a reference to a container which has one or more vials for holding reagents and/or receiving blood samples and which has a stiff spine to hold the vials.

The present invention provides an alternative to the known prior art and the shortcomings identified. The foregoing and other objects and advantages will appear from the description to follow. In the description reference is made to the accompanying representations, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying illustrations, like reference characters designate the same or similar parts throughout the several views. The following detailed description is, therefore, not to be taken in a limiting sense, and the scope of the present invention is best defined by the broad description.

### BRIEF DESCRIPTION OF THE DRAWINGS

The invention will be better understood and objects other than those set forth above will become apparent when consideration is given to the following detailed description thereof. Such description will now be described in more detail according to a preferred but non limiting embodiment and with reference to the accompanying illustrations wherein:

FIG. 1 shows a perspective view of a modular storage receptacle according to a preferred embodiment.

FIG. 2 shows a short side end elevation view of the modular storage receptacle of FIG. 1.

FIG. 3 shows a long side elevation view of the modular storage receptacle.

FIG. 4 shows a plan view of the modular storage receptacle.

FIG. 5 shows a long side elevation view of two co-operating modules in stacked relationship.

FIG. 6 shows a short side elevation view of two co-operating modules in stacked relationship.

FIG. 7 shows an opposite side perspective view of the storage module of FIG. 1-4 with gel cards removed.

FIG. 8 shows a plan view of the storage module of FIG. 7.

### DETAILED DESCRIPTION

The present invention will now be described in more detail according to a preferred but non limiting embodiment and with reference to the accompanying illustrations. The examples referred to herein are illustrative and are not to be regarded as limiting the scope of the invention. While various embodiments of the invention have been described herein, it will be appreciated that these are capable of modification, and therefore the disclosures herein are not to be construed as limiting of the precise details set forth, but to avail such changes and alterations as fall within the purview of the description.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying illustrations and descriptive matter in which there is illustrated various including preferred embodiments of the invention.

The invention is described herein with reference to the Gel test and the use of Gel cards. In that example, the laboratory equipment for the testing includes:

1. Gel Cards (with preloaded Gel, buffer and anti-human globulin (AHG) reagent),and
2. reagent red cells (human red cells of known antigenic profile manufactured to be used in this test system);
3. a pipette for loading the reagent red cells and sample (patient plasma),
4. an incubator capable of incubating the gel card for up to 15 minutes at 37 degrees Celsius; and
5. a centrifuge for spinning the Gel cards once they have been incubated.

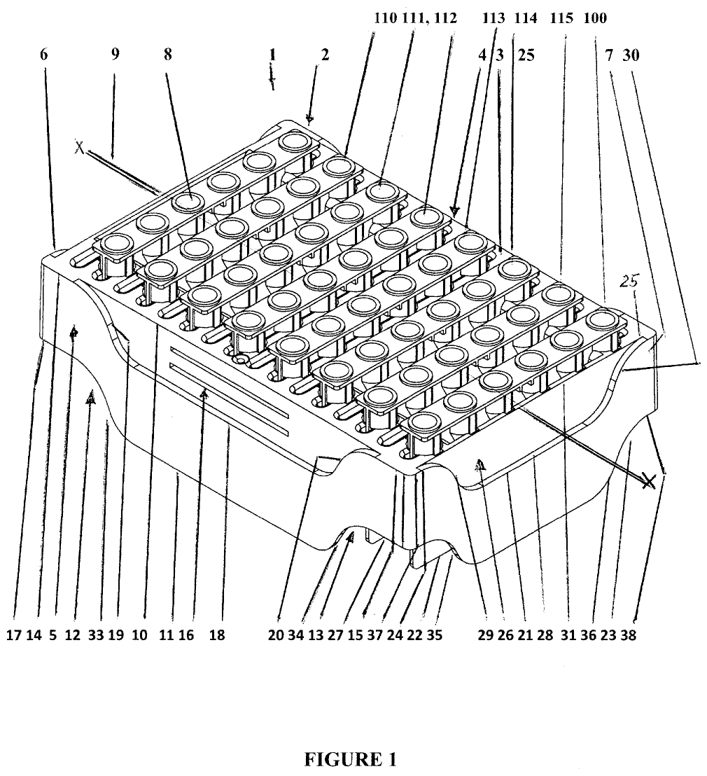

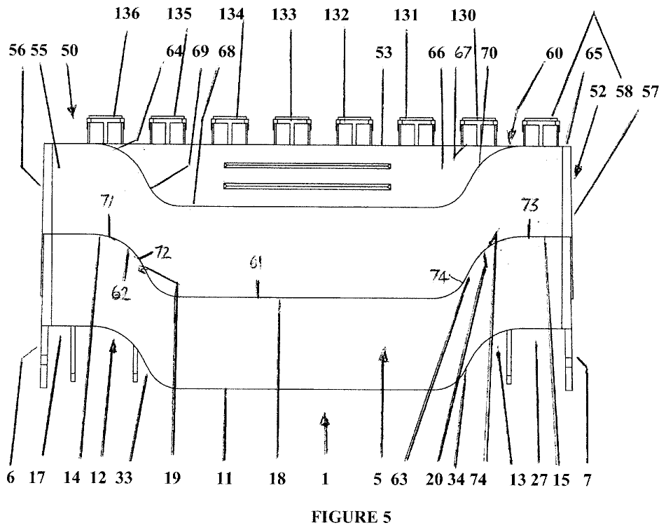

Referring to FIG. 1 there is shown a perspective view of a modular storage device 1 according to a preferred embodiment. Modular storage device 1 comprises a main body 2 having an upper surface 3, side walls 4 and 5 and end walls 6 and 7. Inserted into body 2 via upper surface 3 are a plurality of gel cards 8 110, 111, 112, 113, 114, 115 and 100 each disposed transversely to a long X-X axis 9. Each wall of device 1 is preferably adapted with a geometry which allows one device to nest with a corresponding device. Wall 5 has an upper edge 10 and lower edge 11. Lower edge 11 has abbreviations 12 and 13. The role of abbreviations 12 and 13 will be apparent from the following description with respect to FIG. 5. Upper edge 10 comprises a first edge section 14 extending medially from wall 6 and a second edge section 15 extending medially (preferably normally) from wall 7. Intermediate upper edge sections 14 and 15 is a recess 16 defined by upper edge portion 10, base 18 and splayed side walls 19 and 20.

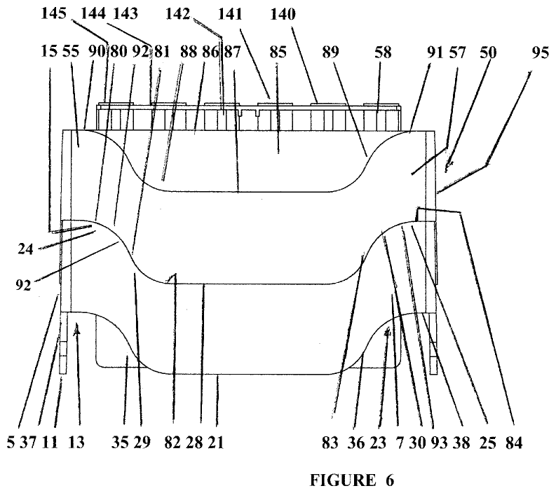

Wall 7 has an upper edge 31 and lower edge 21. Lower edge 21 has abbreviations 22 and 23. The role of abbreviations 22 and 23 will be apparent from the following description with reference to FIG. 6. Upper edge 31 comprises a first edge section 24 extending normally relative to the plane of wall 5 and a second edge section 25 extending medially from wall 4. Intermediate upper edge sections 24 and 25 is a recess 26 defined by upper edge portion 31, base 28 and splayed side walls 29 and 30.

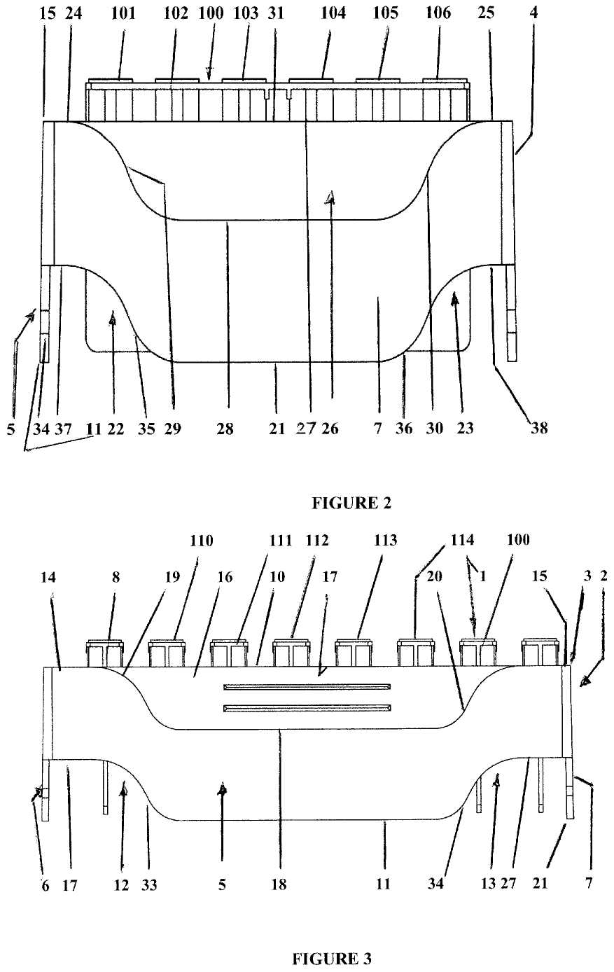

Device 1 as shown is rectangular but it will be appreciated that the device can adopt a number of different shapes such as but not limited to square, triangular or polygonal. In each case at least two walls or wall portions will include an engaging recess of a type similar to that described from walls 5 and 7. However, the inter-fitting geometry of the walls is not to be construed as limiting of the possible nesting geometries. Ideally a part of one wall of a receptacle fits into a wall recess of a corresponding receptacle. Abbreviation 22 is defined by edges 35 and 37 of wall 7. Abbreviation 23 is defined by edges 36 and 38. From the elevation view of FIG. 2, the profiles of wall 7 which allow nesting with a corresponding device above and below can be seen. Abbreviation 12 is defined by edges 17 and 33. Abbreviation 13 is defined by edges 34 and 27.

It will be appreciated by persons skilled in the art that wall 4 (obscured) has similar geometry to that described for wall 5 and wall 6 (obscured) has similar geometry to that described for wall 7. According to an alternative embodiment, a device may be arranged so that it has wall nesting geometry on two of its four sides. In that case the nesting geometry may be located on one long side and one short side or opposing long sides or opposing shorts sides. Alternatively, nesting geometry may be limited to one wall of one portion of one wall.

FIG. 2 shows with corresponding numbering, a short side end elevation view of wall 7 of the modular storage receptacle 1 of FIG. 1. Wall 7 has an upper edge 31 and lower edge 21. Lower edge 21 has abbreviations 22 and 23. Upper edge 31 comprises a first edge section 24 extending medially from wall 5 and a second edge section 25 extending medially from wall 4. Intermediate upper edge sections 24 and 25 is a recess 26 defined by upper edge portion 27, base 28 and splayed side walls 29 and 30. Located in module 1 is a typical known gel card 100 which includes integral vials 101, 102, 103, 104, 105 and 106 which are used as described earlier.

FIG. 3 shows with corresponding numbering, a long side elevation view of the modular storage receptacle. Modular storage receptacle 1 comprises a main body 2 having an upper surface 3, side wall 5 and end walls 6 and 7. Shown inserted into body 2 via upper surface 3 are a plurality of gel cards 8, 110, 111, 112, 113, 114,115 and 100. Each wall of receptacle 1 is adapted with a geometry which allows one receptacle to nest with a corresponding receptacle. Wall 5 has an upper edge 10 and lower edge 11. Lower edge 11 has abbreviations 12 and 13. The role of abbreviations 12 and 13 will be apparent from the following description with respect to FIG. 5. Upper edge 10 comprises a first edge section 14 extending medially from wall 6 and a second edge section 15 extending medially from wall 7. Intermediate upper edge sections 14 and 15 is a recess 16 defined by upper edge portion 17, base 18 and splayed side walls 19 and 20.

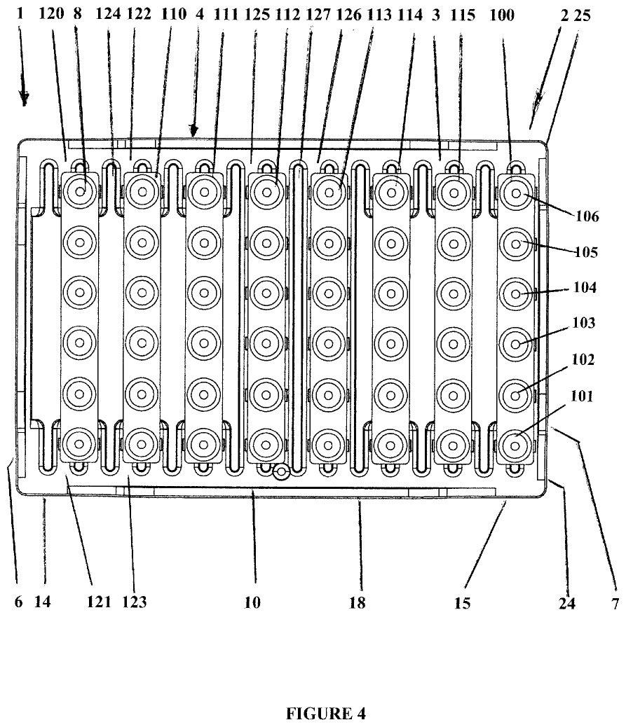

FIG. 4 shows with corresponding numbering a plan view of the modular storage receptacle. This arrangement shows an array of gel cards 8, 110, 111, 112, 113, 114, 115 and 100. Gel card 8 locates between inwardly directed formations 120 and 121. Likewise gel card 110 locates between inwardly directed formations 122 and 123. Slot 124 is defined between abutment formations 120 and 122. This arrangement is repeated along the length of the modular device. At a mid-region of modular device 1, are bridge formations 125 and 126 which span a full width of receptacle module 1. These bridges reinforce side walls 4 advice 5 and also accommodate gel cards 112 and 113. A formation of the type indicated with numeral 120 can extend inwardly to any distance towards the centre (medially) of device 1. As shown formation 120 is abbreviated and provides a side wall abutment. Likewise formation 121 is abbreviated and provides an opposite side wall abutment. FIG. 4 shows eight gel cards, but it will be appreciated that the receptacle module 1 can be adjusted to accommodate more or less gel cards.

FIG. 5 shows a long side elevation view of two co operating modular devices 1 and 50 in stacked relationship. In this arrangement, device 1 is the lowermost module and receptacle 50 is stacked on top of receptacle 1. Modular storage receptacle 50 comprises a main body 52 having an upper surface 53, side wall 55 and end walls 56 and 57. Inserted into body 52 via upper surface 53 are a plurality of gel cards 58. Each wall of receptacle 50 is adapted with a geometry which allows receptacle 50 to nest with receptacle 1. Wall 55 has an upper edge 60 and lower edge 61.

Lower edge 61 has abbreviations 62 and 63. Upper edge 60 comprises a first edge section 64 extending medially from wall 56 and a second edge section 65 extending medially from wall 57. Intermediate upper edge sections 64 and 65 is a recess 66 defined by upper edge portion 67, base 68 and splayed side walls 69 and 70. Abbreviation 62 is defined by edge 71 and edge 72. Abbreviation 63 is defined by edge 73 and 74. When receptacle 50 is coupled with receptacle 1, edges 71, 72, 61, 74 and 73 respectively oppose edges 14, 19, 18, 20 and 15. In a similar manner other receptacles can be stacked on top of receptacle 50 thereby allowing storage of a large number of gel packs in a relatively small footprint.

FIG. 6 shows with corresponding numbering a short side elevation view of two the co operating modules 1 and 50 in stacked relationship. Wall 57 has an upper edge 86 and lower edge 82. Lower edge 82 has abbreviations 92 and 93. Upper edge 86 comprises a first edge section 90 extending medially from wall 55 and a second edge section 91 extending medially from wall 95. Intermediate upper edge sections 90 and 91 is a recess 85 defined by upper edge portion 86, base 87 and splayed side walls 88 and 89. Recess 85 is capable of receiving and retaining a third receptacle. Gel card 58 includes vials 140, 141, 142, 143, 144, 145.

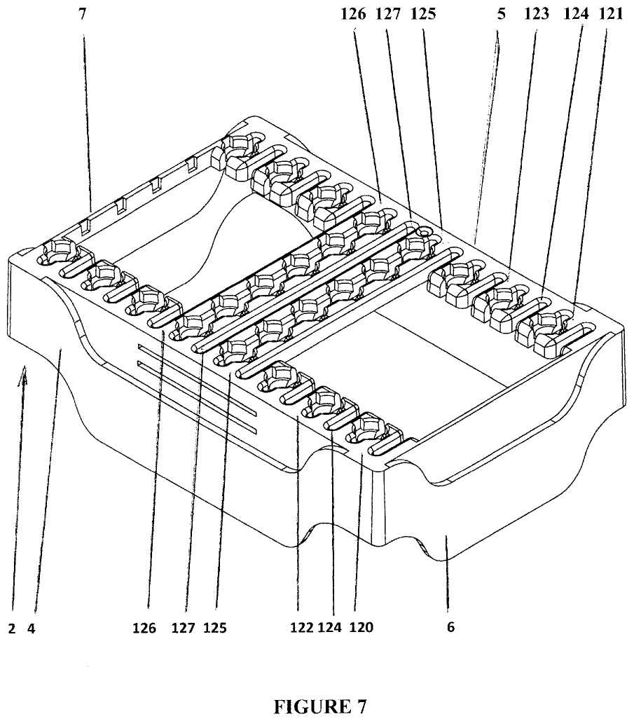

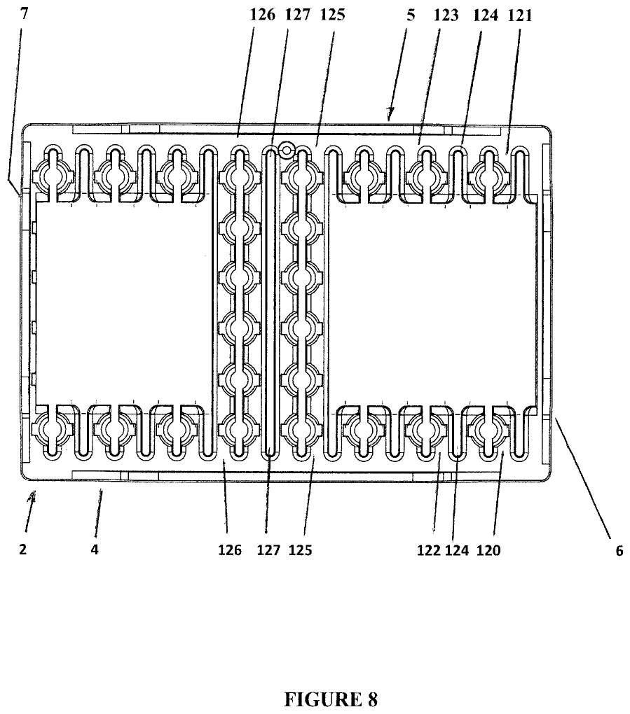

FIG. 7 shows with corresponding numbering opposite side perspective view of the storage module 1 of FIGS. 1 and 4 without gel cards inserted. Since gel cards have been removed the wall formations which support the gel cards can been clearly seen. Walls 4 and 5 have inwardly directed opposing respective formations 120 and 121 providing abutments for gel cards. These formations may be any shape and configuration provided they accommodate at least part of a gel card. Similarly for opposing formations 122 and 123. Slot 124 is defined between abutment formations 120 and 122 and 121 and 123. This arrangement is repeated along the length of the modular receptacle. At a mid-region of modular receptacle 1, are bridge formations 125 and 126 which span a full width of receptacle module 1. These bridges reinforce side walls 4 and Sand are in effect extensions of the abbreviated formations similar to formations 120, 121, 122 and 123. FIG. 8 shows with corresponding numbering a plan view of the storage module of FIG. 7.

According to a preferred embodiment a 24 rack gel card system is considered optimal. A 24 rack system according to the invention takes up the same space as a 16 card rack by volume. This saves considerable space in storage, shipping and in production. Potentially freight costs can be reduced by at least 30%, packaging costs are potentially halved. Another advantage of the present invention is that a 24 rack embodiment may be placed directly on the analyser, saving time and eliminating the possibility of errors. Another advantage is that the receptacle holds the cards eliminating the need for the analyser to pick up the cards and move them into the dispensing area. This allows the gel cards to be charged/filled while remaining in the rack of the receptacle. This reduces space used in the analyser which will enable a decrease in the size and complexity of the analyser.

As a result of this the analysers are faster and more efficient. The 24 racks are designed to be picked up by the analyzer and automatically disposed of with other waste thus requiring no further operator intervention. In existing systems empty racks must be manually removed when empty before new cards can be accepted. New 24 racks can be added as required without interrupting the workflow of the analyzer.

The modular receptacle according to the present invention may be manufactured from a variety of materials including but not limited to plastics, cellulose fibre (including cardboard), metal. According to one embodiment the receptacle is collapsible/foldable. Alternatively, the receptacle may be manufactured in a plastics mould with a potential for reuse.

Although the nesting/mating regime has been described with reference to one front face and one end face, it will be appreciated that the preferred embodiment contemplates a similar mating regime for each of the four walls of the embodiment described. It will further be appreciated that the body of the receptacle according to an alternative embodiment, can adopt alternative shapes such as square, triangular, circular, polygonal as required. In that case the wall mating profile will be adjusted to accommodate the different body shapes but at all time allowing the nesting/stacking of the receptacles.

It will be recognised by persons skilled in the art that numerous variations and modification may be made to the invention broadly described herein without departing from the overall spirit and scope of the invention.

1. A storage device for holding at least one article the device comprising a generally cubic body including side and end walls defining an internal space which receives and retains therein said at least one said articles, at least one said walls including an inwardly extending formation which allows the at least one article to be suspended in the internal space; at least one said walls including a recess which allows nesting engagement of one said device with a like storage device such that at least one device is stackable on another like device; while accommodating said articles in said internal space.

2. A storage device according to claim 1 wherein at least part of each said walls each have a distal edge capable of providing support for the device and an upper edge defining a recess which receives and retains a corresponding distal edge of a like device when one device is stacked on top of another device.

3. A storage device according to claim 2 further comprising a plurality of inwardly extending formations extending from at least two said walls and which provide a recess to accommodate said articles.

4. A storage device according to claim 3 wherein the inwardly extending formations provide abutments to support said articles.

5. A storage device according to claim 4 wherein at least two said inwardly extending formations meet to form a bridge spanning between opposing walls.

6. A storage device according to claim 5 wherein the inwardly extending formations extend from the side walls.

7. A storage device according to claim 6 wherein each said side and end walls have a part including an external surface lying in a first plane and a second part having an external surface lying in a second plane which is offset from the first plane.

8. A storage device according to claim 7 wherein the offset second plane surface defines a wall recess which accommodates a corresponding part of a wall of a like device when one said devices is stacked on another of said devices.

9. A storage device according to claim 8 wherein the recess is inwardly offset relative to the external surface in said first plane.

10. A storage device according to claim 9 wherein each said side and end walls has a distal edge extending for part of the length of each said side walls.

11. A storage device according to claim 10 wherein each end wall has a distal edge extending for part of the length of each said end walls.

12. A storage device according to claim 11 wherein when one device is stacked on top of another like device, a distal edge of each wall of one device nests in the wall recess of the other device.

13. A storage device according to claim 12 wherein the articles are gel cards.

14. A storage device according to claim 13 wherein the formations include a slot which accommodates at least one edge of the gel cards.

15. A storage device according to claim 14 wherein each said formations include a recess which accommodates one receptacle of a gel card.

16. A storage device according to claim 15 wherein the gel cards are inserted and held in an elongated slot in the formations.

17. A storage device according to claim 16 wherein there are a plurality of slots which allow insertion of a plurality of gel cards into said device.

18. A storage device according to claim 17 wherein each distal end of each wall terminates in abbreviated contours.

19. A storage device according to claim 18 wherein multiple devices are stackable one on top of the other.

20. A storage device according to claim 19 wherein each device accommodates at least five gel cards.

21. A storage device according to claim 20 wherein the gel cards are when inserted oriented normally to the side walls.

22. A storage device according to claim 21 wherein the device is manufactured from moulded plastics.

23. (canceled)

23. (canceled)

25. A modular storage device for holding at least one gel card, the device comprising a generally cubic body including, side and end walls which define an internal space which receives and retains therein said gel cards; formations extending from at least one said walls which retain said at least one gel cards; at least two said walls arranged to allow nesting engagement with corresponding walls of a like storage device such that one modular storage device is stackable with at least one other device.

26. A modular storage device according to claim 25 wherein at least one said side wall has a distal edge capable of providing support for the device and an upper edge; a formation at or near the upper edge which receives and retains a corresponding distal edge of a like device.

27. A modular storage device for holding a plurality of gel cards; the device comprising a generally cubic body including an article entry opening, side and end walls each terminating in a distal edge which supports the device when disposed on a support surface; the entry wall, side and end walls defining an internal space which receives and at least partially retains said plurality of gel cards; each said side wall including an upper proximal edge at least part of which is integral with an edge of said upper entry wall; a formation in each said wall which matches a distal edge formation in a wall of a corresponding device, wherein in a stacked state a distal edge of a wall of one device locates in a corresponding wall formation in a proximal edge part of a second device thereby enabling inter fitting of one device to another like device.

28. (canceled)
